(19) United States
(12) Patent Application Publication
(10) Pub. No.: US 2008/0028219 A1
(43) Pub. Date: Jan. 31, 2008

(54) Provisioning Privacy on Communication Networks

(75) Inventor: Robert C. Booth, Ivyland, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/616,942

(22) Filed: Dec. 28, 2006

Related U.S. Application Data
(60) Provisional application No. 60/820,911, filed on Jul. 31, 2006.

(51) Int. Cl. H04L 9/32

(52) U.S. Cl. 713/171

(57) ABSTRACT

An arrangement is disclosed for provisioning privacy settings on a terminal, such as a set top box (“STB), that resides on a shared infrastructure like a coaxial cable network so that conflicts with existing installed terminals are avoided through the use of privacy key that comprises a reserved field and a key field. If the STB has privacy disabled by default, then it is arranged to be initialized with a random privacy key created by using a randomly generated string (e.g., a number, binary bits, alphanumeric string, or character string) for the key field which is combined with a first reserved string used to populate the reserved field. If the STB has privacy enabled by default, then the STB is initialized with a configured privacy key created by acquiring a PIN (personal identification number) for the key field that is combined with a second reserved string for the reserved field. The first and second reserved strings are arranged to map several types of STB state information into the reserved field which thus establishes uniqueness among the created privacy keys. In an illustrative example, such states include default privacy setting (e.g., enabled or disabled), set top origin (e.g., retail purchase or MSO-supplied) and PIN origin (e.g., supplied by a user or supplied by a remote provisioning system or controller).

### STATEMENT OF RELATED APPLICATION

This application claims the benefit of provisional application No. 60/820,911, filed Jul. 31, 2006, the disclosure of which is incorporated by reference herein.

### BACKGROUND

Digital video recorders (“DVRs”) have become increasingly popular for the flexibility and capabilities offered to users in selecting and then recording video content such as that provided by cable and satellite television service companies. DVRs are consumer electronics devices that record or save television shows, movies, music, and pictures, for example, (collectively “multimedia”) to a hard disk in digital format. Since being introduced in the late 1990s, DVRs have steadily developed additional features and capabilities, such as the ability to record high definition television (“HDTV”) programming. DVRs are sometimes referred to as personal video recorders (“PVRs”).

DVRs allow the “time shifting” feature (traditionally enabled by a video cassette recorder or “VCR”), where programming is recorded for later viewing to be performed more conveniently, and also allow for special recording capabilities such as pausing live TV, fast forward and fast backward, instant replay of interesting scenes, and skipping advertising and commercials.

DVRs were first marketed as standalone consumer electronic devices. Currently, many satellite and cable service providers are incorporating DVR functionality directly into their set-top-boxes (“STBs”). As consumers become more aware of the flexibility and features offered by DVRs, they tend to consume more multimedia content. Thus, service providers often view DVR uptake by their customers as being desirable to support the sale of profitable services such as video on demand (“VOD”) and pay-per-view (“PPV”) programming.

Once consumers begin using a DVR, the features and functionalities it provides are generally desired throughout the home. To meet this desire, networked DVR functionality has been developed which entails enabling a DVR to be accessed from multiple rooms in a home over a network. Such home networks often employ a single, large capacity DVR that is placed near the main television in the home. A series of smaller companion terminals, which are connected to other televisions, access the networked DVR over the typically existing coaxial cable in the home. These companion terminals enable users to see the DVR output, and to use the full range of DVR controls (pause, rewind, and fast-forward among them) on the remotely located televisions. In some instances, it is possible, for example, to watch one recorded DVR movie in the office while somebody else is watching a different DVR movie in the family room.

The home network must be secured so that the content stream from the DVR is not unintendedly viewed should it leak back through the commonly shared outside coaxial cable plant to a neighboring home or adjacent subscriber in a multiple dwelling unit (“MDU”) such as an apartment building. In some implementations of home networking, a low pass filter is installed at the entry point of the cable into the home to provide radio frequency (“RF”) isolation. However, the low pass filter is not always well suited to installation by consumers (termed a “self-install”) and the truck roll costs associated with professional installation are generally undesirable.

Another implementation of home networking security is provided using MoCA (Multimedia over Coax Alliance)-compliant terminals in which privacy may be managed at the device-level using a network access controller or network interface module (“NIM”). Here, a privacy identifier must be installed at each terminal for the home network to be formed. Media content, such as that from a networked DRV, is securely shared only among terminals that have the commonly-utilized PIN. Terminals that do not have the correct privacy identifier are not able to access the network or share the stored content on the networked DVR.

In some scenarios, the privacy feature is disabled by default at the terminal. This means content on the terminal could be accessed without a privacy identifier and no privacy identifier is set or stored in the terminal. Privacy could be disabled by default, for example, in terminal devices that are sold at retail to consumers. Ease of self-installation by a consumer is given precedence over the risk that content on the terminal device may be leaked. In other scenarios, the privacy setting is enabled by default at the terminal. This means that the terminal requires provisioning with a PIN in order to be initialized and placed into service on the network. Privacy is typically enabled by default in terminals that are supplied or rented from an operator, such as a multiple system operator (“MSO”), that provides a cable television or multimedia service.

While networked DVRs meet the needs of the market very well, there is currently no mechanism with which to provision privacy settings in a mixed population of terminals where some of the devices have privacy enabled by default and others have privacy disabled by default. This can present problems to consumers and operators alike as home networks are expected to grow using both retail and operator terminal delivery models.

### DESCRIPTION OF THE DRAWINGS

FIG. 1 is a pictorial representation of an illustrative home network having a plurality of terminal devices that are coupled to several broadband multimedia sources;

FIG. 2 is a block diagram of an illustrative multimedia delivery network having a network headend, hubs coupled to the headend, and nodes coupled to the hubs, where the nodes each provide broadband multimedia services to a plurality of homes;

FIG. 3 is a pictorial representation of an illustrative multiple dwelling unit having a number of apartments, each with a plurality of terminal devices, where the apartments share common infrastructure to receive broadband multimedia services;

FIG. 4 is a simplified block diagram of an illustrative wide area network and a local area network which share a common portion of physical infrastructure;

FIG. 5 is a simplified functional block diagram of an illustrative local area network having a plurality of terminal devices that are also coupled to a wide area network;

FIG. 6 is a pictorial illustration of graphical user interfaces displayed on a home multimedia server and client set top box;

FIG. 7 is a simplified functional block diagram showing an illustrative network headend coupled over a wide area network to the household of a subscriber;

FIG. 8 is a simplified block diagram of an architecture for an illustrative set top box;

FIG. 9 is a diagram of an illustrative privacy key object;

FIG. 10 is a diagram of an illustrative random privacy key object;

FIG. 11 is a diagram of an illustrative configured privacy key object;

FIG. 12 is a flowchart of an illustrative method for provisioning a privacy key;

FIG. 13 is a diagram showing the mapping of terminal state information to a reserved field having three digits; and

FIG. 14 is a diagram showing an illustrative shared-key authentication message flow between terminals over a local area network.

### DETAILED DESCRIPTION

An arrangement is disclosed for provisioning privacy settings on a terminal, such as an STB, that resides on a shared infrastructure like a coaxial cable network so that conflicts with existing installed terminals are avoided through the use of a privacy key that comprises a reserved field and a key field. If the STB has the privacy disabled by default, then it is arranged to be initialized with a random privacy key created by using a randomly generated string (e.g., a number, binary bits, alphanumeric string, or character string) for the key field which is combined with a first reserved string used to populate the reserved field. If the STB has the privacy enabled by default, then the STB is initialized with a configured privacy key created by acquiring a PIN (personal identification number) for the key field that is combined with a second reserved string for the reserved field. The first and second reserved strings are arranged to map several types of STB state information into the reserved field which thus establishes uniqueness among the created privacy keys. In an illustrative example, such states include default privacy setting (e.g., enabled or disabled), set top origin (e.g., retail purchase or MSO-supplied) and PIN origin (e.g., supplied by a user or supplied by a remote provisioning system or controller).

The present arrangement advantageously avoids conflicts with existing terminals installed on a network, including networks that utilize a mixed population of terminal devices in which some of the devices have privacy enabled by default and others have privacy disabled by default. The uniqueness of the privacy keys provided by the state-dependent reserved field ensures a high probability that the privacy identifier created for any newly installed STB will not be the same as a privacy identifier used by STBs on an existing network that shares the same coaxial cable infrastructure.

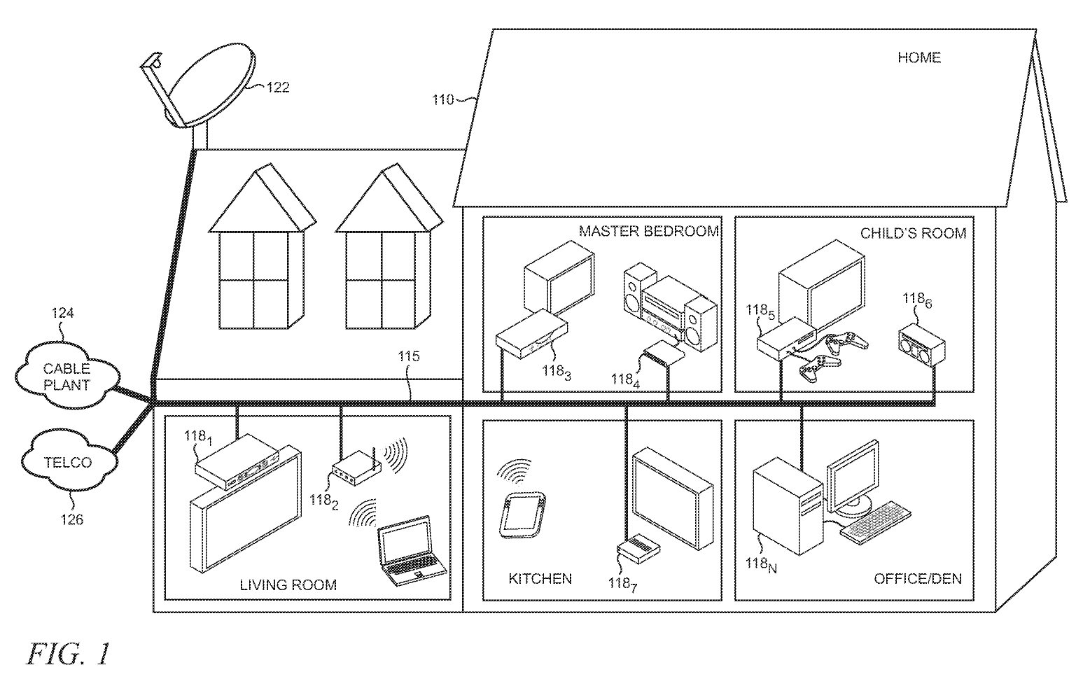

Turning now to FIG. 1, a pictorial representation of an illustrative arrangement is provided which shows a home 110 with infrastructure 115 to which a plurality of illustrative terminal devices 118₁ to 118_{N} are coupled. Connected to the terminal devices 118 are a variety of consumer electronic devices that are arranged to consume multimedia content. For example, terminal device 118₁ is an STB with an integrated networkable DVR which functions as a home network multimedia server, as described in detail below.

Several network sources are coupled to deliver broadband multimedia content to home 110 and are typically configured as WANs (wide area networks). A satellite network source, such as one used in conjunction with a DBS (direct broadcast satellite) service is indicated by reference numeral 122. A cable plant 124 and a telecommunications network 126, for example, for implementing a digital subscriber line (“DSL”) service, are also coupled to home 110.

In the illustrative arrangement of FIG. 1, infrastructure 115 is implemented using coaxial cable that is run to the various rooms in the house, as shown. Such coaxial cable is commonly used as a distribution medium for the multimedia content provided by network sources 122, 124, and 126. In alternative examples, infrastructure 115 is implemented using telephone or power wiring in the home 110. In accordance with the present arrangement for remotely provisioning a common PIN, infrastructure 115 also supports a home LAN (local area network), and more particularly, a home multimedia network.

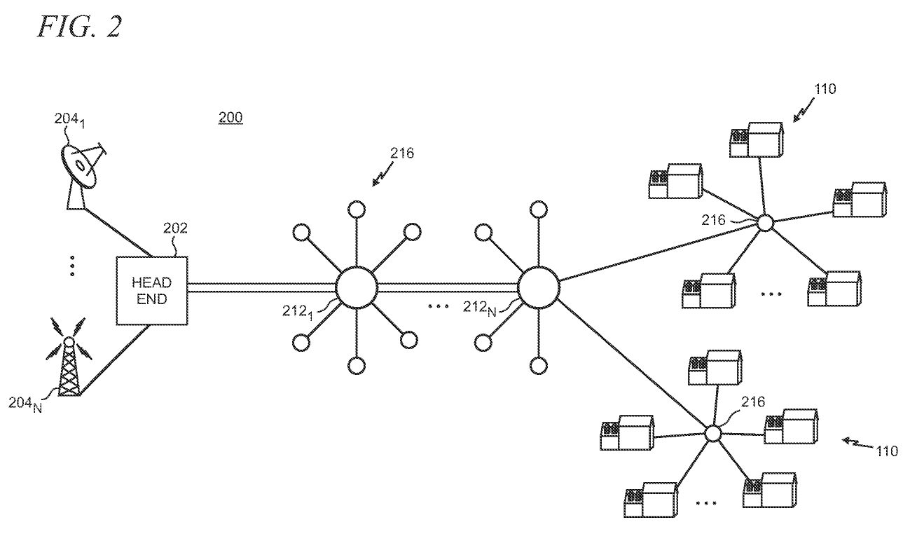

FIG. 2 is a block diagram of an illustrative multimedia delivery network 200 having a network headend 202, hubs 212₁ to 212_{N} coupled to the headend 202, and nodes (collectively indicated by reference numeral 216) coupled to the hubs 212. Nodes 216 each provide broadband multimedia services to a plurality of homes 110, as shown. Multimedia delivery network 200 is, in this example, a cable television network. However, DBS and telecommunication networks are operated with substantially similar functionality.

Headend 202 is coupled to receive programming content from sources 204, typically a plurality of sources, including an antenna tower and satellite dish as in this example. In various alternative applications, programming content is also received using microwave or other feeds including direct fiber links to programming content sources.

Network 200 uses a hybrid fiber/coaxial (“HFC”) cable plant that comprises fiber running among the headend 202 and hubs 212 and coaxial cable arranged as feeders and drops from the nodes 216 to homes 110. Each node 216 typically supports several hundred homes 110 using common coaxial cable infrastructure in a tree and branch configuration. As a result, as noted above, the potential exists for content stored on a networked DVR in one home on a node to be unintendedly viewed by another home on the node unless steps are taken to isolate the portions of the cable plant in each home that are utilized to implement the home multimedia network.

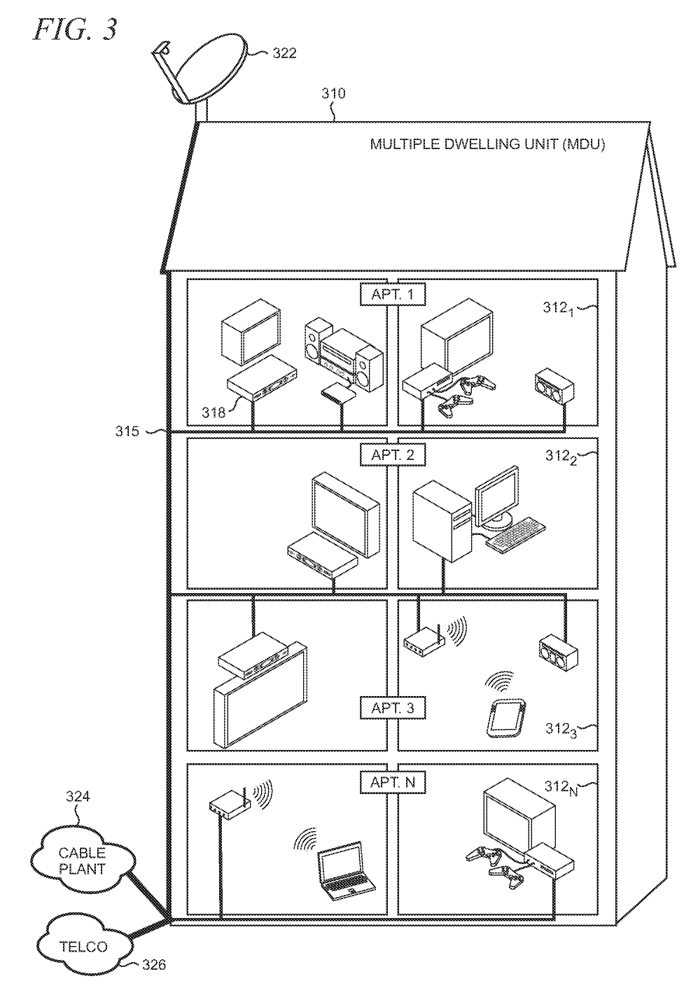

FIG. 3 is a pictorial representation of an illustrative multiple dwelling unit 310 having a number of apartments 312₁ to 312_{N}, each with a plurality of terminal devices coupled to a common coaxial cable infrastructure 315. In a similar manner to that shown in FIG. 1 and described in the accompanying text, MDU 310 receives broadband multimedia services from WANs including a satellite network source 322, cable plant 324, and telecommunications network 326.

Apartments 312 each use respective portions of infrastructure 315 to implement a LAN comprising a home multimedia network. Since apartments 312 share common infrastructure 315, measures must be taken to isolate each home multimedia network in the MDU so that content stored, for example, on a networkable DVR in STB 318 in apartment 1, is not unintendedly viewed in apartment 2 in MDU 310.

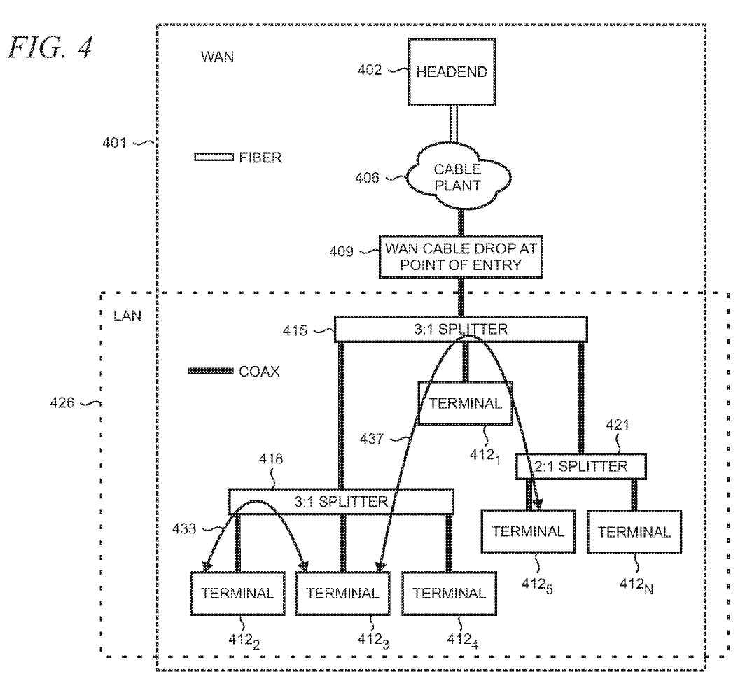

FIG. 4 shows an example of how the wide area and local area networks described above share a common portion of physical infrastructure. A WAN 401, for example a cable television network, includes a headend 402 and cable plant 406. Cable plant 406 is typically arranged as an HFC network having coaxial cable drops at a plurality of terminations at broadband multimedia service subscribers' buildings such as homes, offices, and MDUs. One such cable drop is indicated by reference number 409 in FIG. 4.

From the cable drop 409, WAN 405 is coupled to individual terminals 412₁ to 412_{N} using a plurality of splitters, including 3:1 splitters 415 and 418 and a 2:1 splitter 421 and coaxial cable (indicated by the heavy lines in FIG. 4). It is noted that the number and configuration of splitters shown in FIG. 4 is illustrative and other types and quantities of splitters will vary depending on the number of terminals deployed in a particular application. Headend 402 is thus coupled directly to each of the terminals 412 in the household to enable multimedia content to be streamed to the terminals over the WAN 401. In most applications, terminals 412 and cable plant 406 are arranged with two-way communication capability so that signals which originate at a subscriber's household can be delivered back upstream to the headend. Such capability enables the implementation of a variety of interactive services. It further provides a subscriber with a convenient way to order services from the headend, make queries as to account status, and browse available multimedia choices using an electronic programming guide (“EPG”), for example.

In typical applications WAN 401 operates with multiple channels using RF signals in the range of 50 to as high as 860 Mhz for downstream communications (i.e., from headend to terminal). Upstream communications (i.e., from terminal to headend) have a typical frequency range from 5 to 42 MHz.

LAN 426 commonly shares the portion of networking infrastructure installed at the building with WAN 401. More specifically, as shown in FIG. 4, the coaxial cable and splitters in the building are used to enable inter-terminal communication. This is accomplished using a network or communications interface in each terminal, such as a network interface module (“NIM”), chipset or other circuits, that provides an ability for an RF signal to jump backwards through one or more splitters. Such splitter jumping is illustratively indicated by arrows 433 and 437 in FIG. 4.

In many applications, LAN 426 is arranged with the capability for operating multiple RF channels in the range of 800-1550 MHz, with a typical operating range of 1 to 1.5 GHz. LAN 426 is generally arranged as an IP (Internet protocol) network. Other networks operating at other RF frequencies may optionally use portions of the LAN 426 and WAN 401 infrastructure. For example, a broadband internet access network using a cable modem (not shown), voice over internet protocol (“VOIP”) network, and/or out of band (“OOB”) control signaling and messaging network functionalities are commonly operated on LAN 426 in many applications.

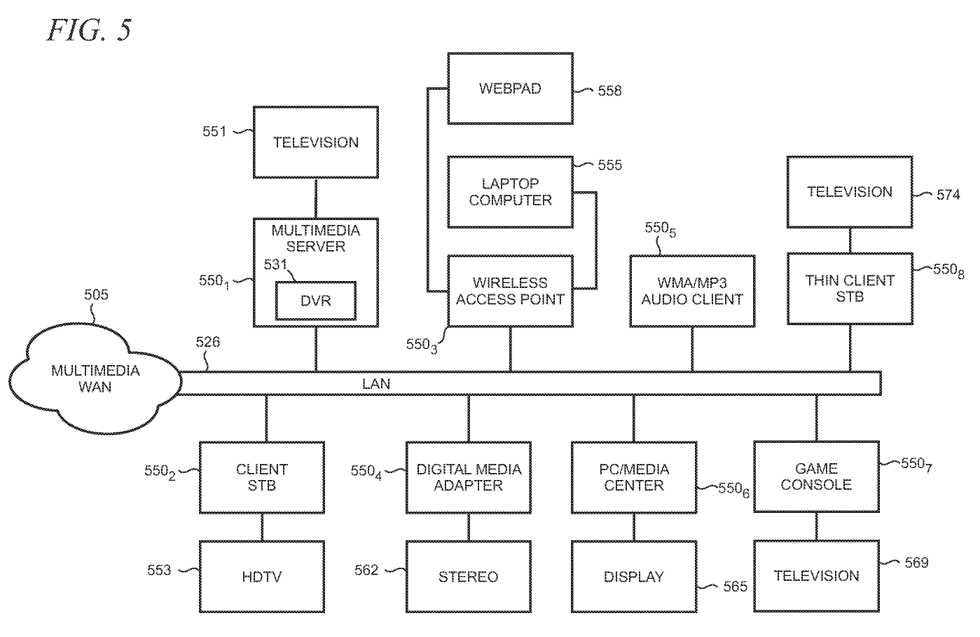

FIG. 5 is a functional block diagram of an illustrative LAN 526, having a plurality of coupled terminal devices 550, that is operated in a multimedia service subscriber's home. As with the arrangement shown in FIG. 4 and described in the accompanying text, the terminal devices coupled to LAN 526 are also coupled to a WAN 505 to receive multimedia content services such as television programming, movies, and music from a service provider. Thus, WAN 505 and LAN 526 share a portion of common networking infrastructure, which in this example is coaxial cable, but operate at different frequencies.

A variety of terminal devices 550₁₋₈ are coupled to LAN 526 in this illustrative example. A multimedia server 550₁ is coupled to LAN 526. Multimedia server 550₁ is arranged using an STB with integrated networkable DVR 531. Alternatively, multimedia server 550₁ is arranged from devices such as personal computers, media jukeboxes, audio/visual file servers, and other devices that can store and serve multimedia content over LAN 526. Multimedia server 550₁ is further coupled to a television 551.

Client STB 550₂ is another example of a terminal that is coupled to LAN 526 and WAN 505. Client STB 550₂ is arranged to receive multimedia content over WAN 505 which is played on the coupled HDTV 553. Client STB 550₂ is also arranged to communicate with other terminals on LAN 526, including for example multimedia server 550₁, in order to access content stored on the DVR 531. Thus, for example, a high definition PPV movie that is recorded on DVR 531 in multimedia server 550₁, located in the living room of the home, can be watched on the HDTV 553 in the home's family room.

Wireless access point 550₃ allows network services and content from WAN 505 and LAN 526 to be accessed and shared with wireless devices such as laptop computer 555 and webpad 558. Such devices with wireless communications capabilities (implemented, for example, using the Institute of Electrical and Electronics Engineers IEEE 802.11 wireless communications protocols) are commonly used in many home networking applications. Thus, for example, photographs stored on DVR 531 can be accessed on webpad 558 that is located in the kitchen of the home over LAN 526.

Digital media adapter 550₄ allows network services and content from WAN 505 and LAN 526 to be accessed and shared with media players such as home entertainment centers or stereo 562. Digital media adapter 550₄ is typically configured to take content stored and transmitted in a digital format and convert it into an analog signal. For example, a streaming internet radio broadcast received from WAN 505 and recorded on DVR 531 is accessible for play on stereo 562 in the home's master bedroom.

WMA/MP3 audio client 550₅ is an example of a class of devices that can access digital data directly, without the use of external digital to analog conversion. WMA/MP3 client 550₅ is a music player that supports the common Windows Media Audio digital file format and/or the Moving Picture Expert Group (“MPEG”) Audio Layer 3 digital file format, for example. WMA/MP3 audio client 550₅ might be located in a child's room in the home to listen to a music channel supplied over WAN 505 or to access an MP3 music library that is stored on DVR 531 using LAN 526.

A personal computer, PC 550₆ (which is optionally arranged as a media center-type PC typically having one or more DVD drives, a large capacity hard disk drive, and high resolution graphics adapter) is coupled to WAN 505 and LAN 526 to access and play streamed or stored media content on coupled display device 565 such as a flat panel monitor. PC 550₆, which for example is located in an office/den in the home, may thus access recorded content on DVR 531, such as a television show, and watch it on the display device 565. In alternative arrangements, PC 550₆ is used as a multimedia server having similar content sharing functionalities and features as multimedia server 550₁ that is described above.

A game console 550₇ and coupled television 569, as might be found in a child's room, is also coupled to WAN 505 and LAN 526 to receive streaming and stored media content, respectively. Many current game consoles play game content as well as media content such as video and music. Online internet access is also used in many settings to enable multi-player network game sessions.

Thin client STB 550₈ couples a television 574 to WAN 505 and LAN 526. Thin client STB 550₈ is an example of a class of STBs that feature basic functionality, usually enough to handle common EPG and VOD/PPV functions. Such devices tend to have lower powered central processing units and less random access memory than thick client STBs such as multimedia server 550₁ above. Thin client STB 550₈ is, however, configured with sufficient resources to host a user interface that enables a user to browse, select, and play content stored on DVR 531 in multimedia server 550₁. Such user interface is configured, in this illustrative example, using an EPG-like interface that allows remotely stored content to be accessed and controlled just as if content was originated to thin client STB 550₈ from its own integrated DVR. That is, the common DVR programming controls including picking a program from the recorded library, playing it, using fast forward or fast back, and pause are supported by the user interface hosted on thin client STB 550₈ in a transparent manner for the user.

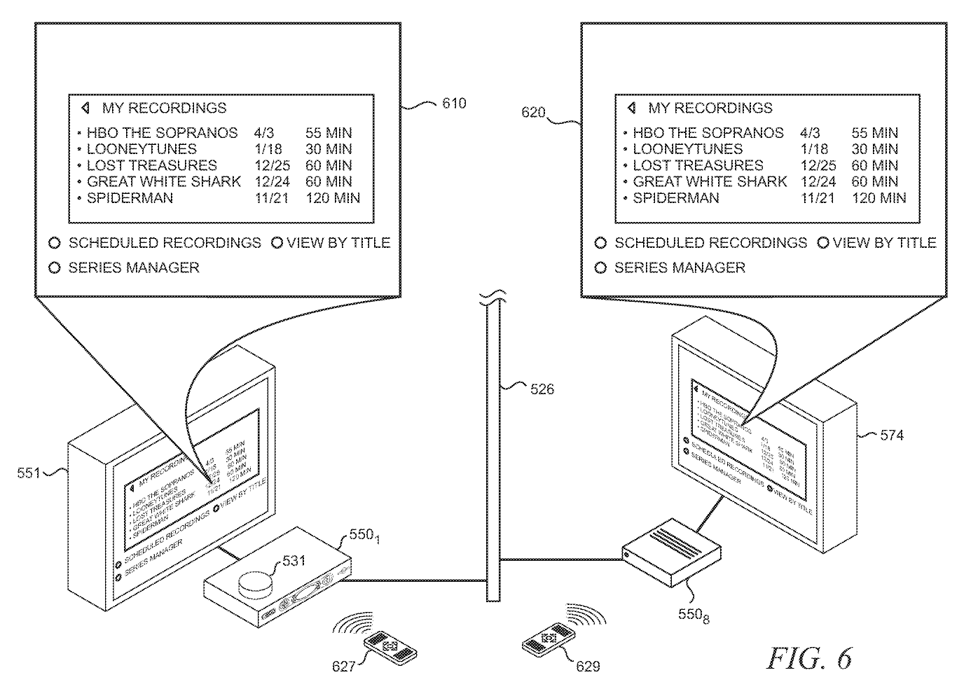

FIG. 6 is a pictorial illustration of the graphical user interfaces displayed on televisions 551 and 574 that are hosted by home multimedia server 550₁ and thin client STB 550₈ respectively, which are coupled to LAN 526 as shown. Graphical user interface (“GUI”) 610 shows the content recorded on DVR 531 including a title, date recorded and program length. A user typically interacts with GUI 610 using a remote control 627 to make recordings, set preferences, browse and select the content to be consumed.

Thin client STB 550₈ hosts GUI 620 with which the user interacts using remote control 629. As shown, GUI 620 displays the same content and controls as GUI 610. Content selected by the user for consumption on television 574 is shared over LAN 526.

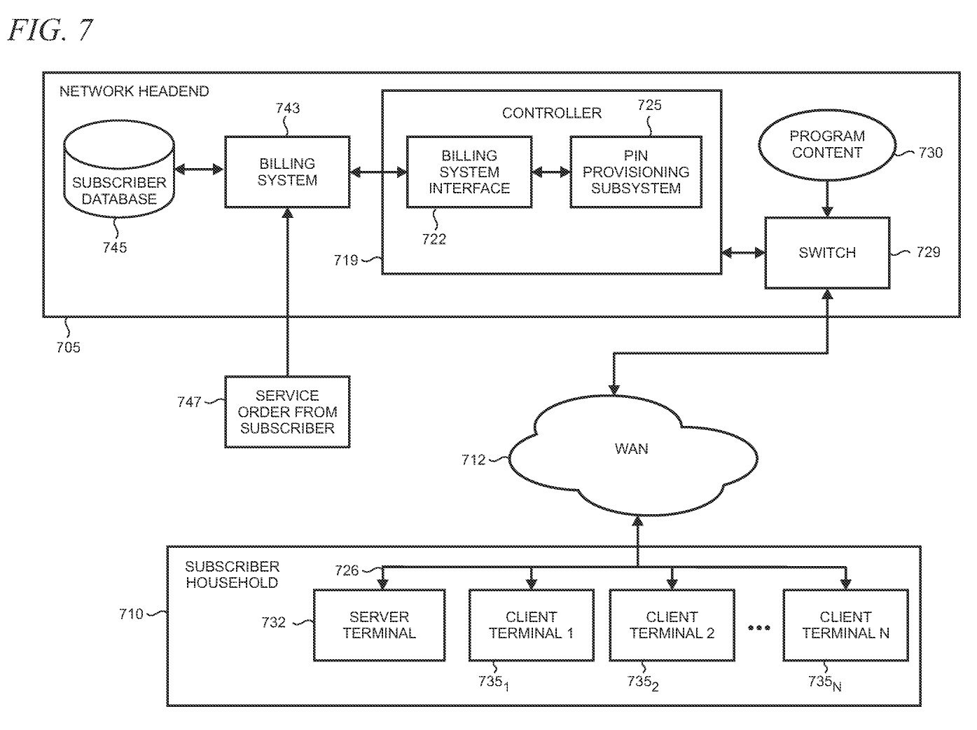

FIG. 7 is functional block diagram showing an illustrative arrangement 700 that includes a network headend 705 that is coupled over a WAN 712 to subscriber household 710. WAN 712 is arranged in a similar manner to WAN 401 shown in FIG. 4 and described in the accompanying text. Network headend 705 includes a controller 719 having a billing system interface 722. A PIN provisioning subsystem 725, such as a server, is operatively coupled to the billing system interface 722. PIN provisioning subsystem 725 may be alternatively embodied as a PIN server as described in co-pending U.S. patent application no. [BCS04081] or as a terminal association identification server as described in co-pending U.S. patent application no. [BCS04349] the disclosures of which are incorporated by reference having the same effect as if set forth at length herein. Accordingly, a value provided by the PIN provisioning subsystem 725 comprises a unique identification that may be selected from one of terminal association identifier, PIN, hash value of the terminal association value, or hash value of the PIN.

Controller 719 is operatively coupled to a switch 729 (that typically includes multiplexer and/or modulator functionality) that modulates programming content 730 from sources 204 (FIG. 2) on to the WAN 712 along with control information, messages, and other data, using the OOB network channel.

A plurality of terminals including a server terminal 732 and client terminals 735₁ to 735_{N} are disposed in subscriber household 710. Server terminal 732 is alternatively arranged with similar features and functions as multimedia server 550₁ (FIG. 5) or PC/Media Center 550₆ (FIG. 5). Client terminals 735 are arranged with similar features and functions as client STB 550₂ or thin client STB 550₈ (FIG. 5). Server terminal 732 and client terminals 735 are coupled to LAN 726 which is, in this illustrative example, arranged using coaxial cable infrastructure in a similar arrangement as LAN 526 (FIG. 5).

Billing system interface 722 is arranged to receive data from a billing system 743 that is disposed in the network headend 705. Billing system 743 is generally implemented as a computerized, automated billing system that is connected to the outgoing PIN provisioning subsystem 725, among other elements, at the network headend 705. Billing system 743 readily facilitates the various programming and service options and configurations available to subscribers which typically results, for example, in the generation of different monthly billing for each subscriber. Data describing each subscriber, and the programming and service options associated therewith, are stored in a subscriber database 745 that is operatively coupled to the billing system 743.

Service orders from the subscribers are indicated by block 747 in FIG. 7 which are input to the billing system 743. Such orders are generated using a variety of input methods including telephone, internet, or website portals operated by the service provider, or via input that comes from a terminal in subscriber household 710. In this latter case, a user typically interacts with a GUI or EPG that is hosted on one of the terminals 732 or 735.

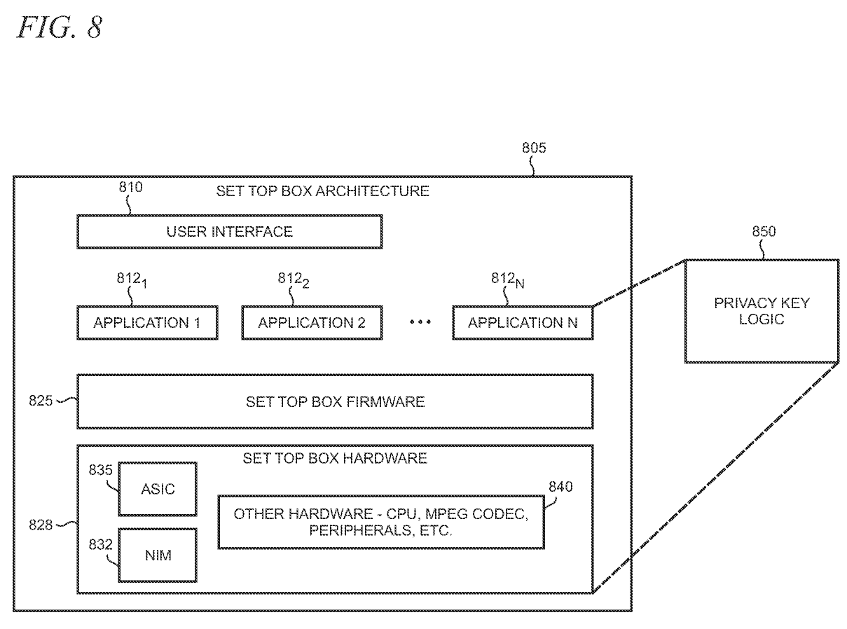

FIG. 8 is a simplified block diagram of an architecture for an illustrative STB 805. The STB architecture 805 is typical of terminals located at the subscriber household 710 in FIG. 7 (including server terminal 732 and client terminals 735). STB 805, in this illustrative example, includes a group of applications 812_{1-N} which is a common configuration in most scenarios. However, in other scenarios, STB 805 may include a single application. Applications 812 provide a variety of common STB functionalities including, for example, EPG functions, DVR recording, web browsing, email, support for electronic commerce and the like.

A user interface 810 is provided in STB 805 to display prompts and receive user input, typically using EPG-type menus displayed on a monitor or television that is coupled to STB 805. User interface 810 may be implemented using a software application or is alternatively implemented using an application programming interface (“API”) that is commonly accessed by applications 812.

STB firmware 825, which is resident in STB 805 in a layer between the applications 812 and STB hardware 828, functions as an intermediary between these architecture layers and also typically performs lower level functions for the STB 805 including, for example, functions that support the applications 812. Below the firmware 825 in architecture 805 is a layer of abstracted STB hardware 828. Hardware 828 includes a network interface or adapter function provided by NIM 832, one or more application specific integrated circuits (“ASIC”) collectively represented by reference numeral 835, along with other hardware 840 including, for example, interfaces, peripherals, ports, a CPU (central processing unit), MPEG codec, memory, and various other components that are commonly utilized to provide conventional STB features and functions.

Privacy key logic 850 is a logical component of STB 805 that may be discretely physically embodied in some applications in either hardware 828 (e.g., using ASIC 835), firmware 825, or software (e.g., applications 812), or a combination thereof. Privacy key logic 850 is arranged to create a privacy key as described below.

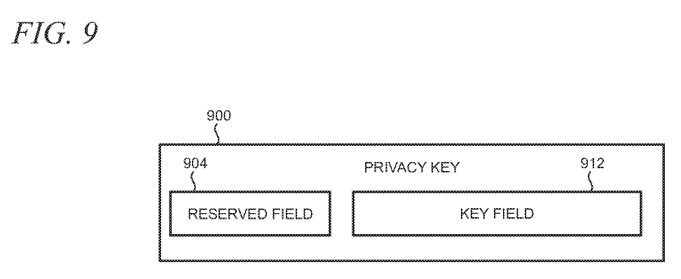

FIG. 9 is a diagram of an illustrative generalized privacy key object 900 which comprises a reserved field 904 and a key field 912. Reserved field 904 is used to hold information relating to STB state. As noted above, such state illustratively includes default privacy setting (e.g., whether enabled or disabled), set top origin (e.g., whether retail purchased or MSO-supplied) and PIN origin (e.g., whether supplied by a user at user interface 815 in FIG. 8 or supplied by a remote provisioning system or controller such as provisioning system 725 in FIG. 7).

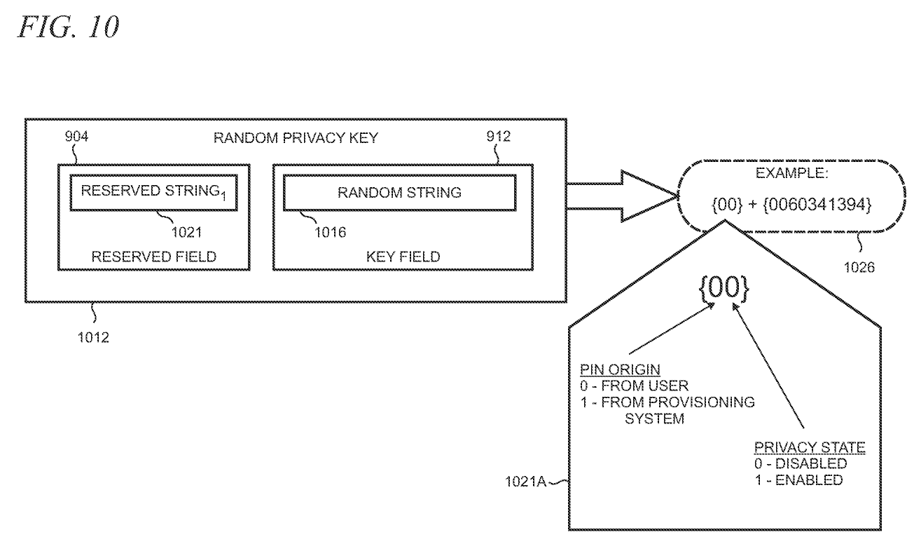

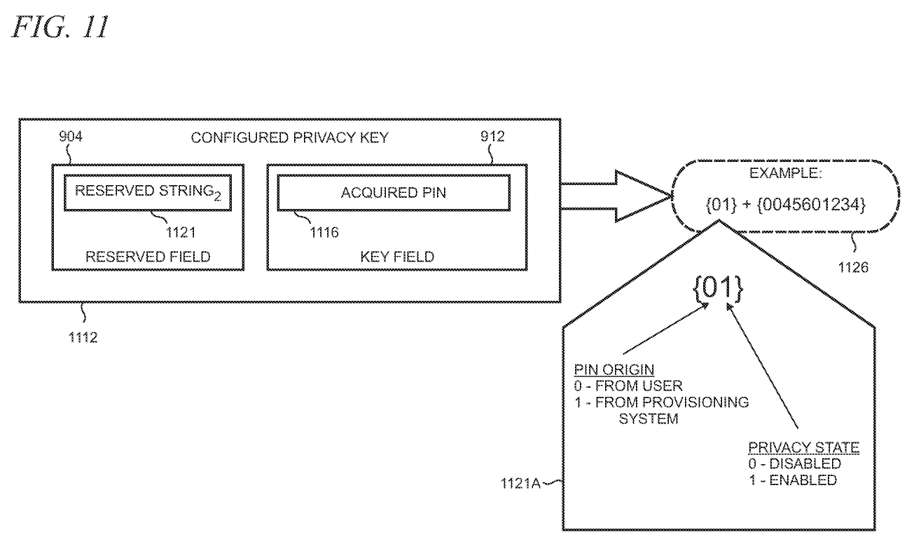

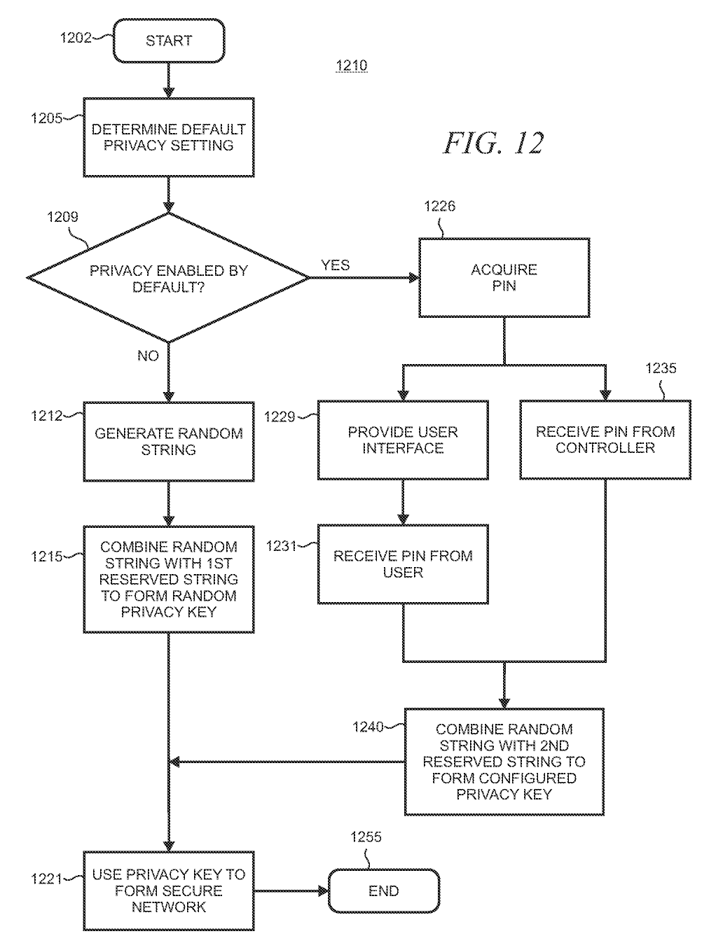

FIGS. 10 and 11 are diagrams of specific privacy key objects. Specifically, FIG. 10 shows an illustrative random privacy key object 1012. FIG. 11 shows an illustrative configured privacy object 1112. These specific privacy key types are described in the discussion accompanying the illustrative method shown in FIG. 12.

FIG. 12 is a flowchart of an illustrative method 1210 for provisioning a privacy key. Illustrative method 1210 may be performed by privacy key logic 850 in STB 805 as shown in FIG. 8 and described in the accompanying text. Illustrative method 1210 starts at block 1202. At block 1205, in this illustrative example, privacy key logic 850 is arranged to determine the default privacy setting of STB 805. Such determination may typically occur during the initialization of a STB (i.e., when being powered up initially or after a reset), or when a new STB is being added to an existing network).

At decision block 1209, if the result of the determination at block 1205 is that privacy is disabled, then control passes to block 1212. At block 1212 (referring to FIG. 10) privacy key logic 850 generates a random string 1016 that is used to populate the key field 912 using a conventional random number generation algorithm. The random string 1016 may alternatively comprise numbers, binary bits, an alphanumeric string, or a character string. The length of the random string 1016 and corresponding key field size can vary according to requirements of a specific application of privacy key provisioning. However, in most applications, a privacy key having between 10 and 15 digits is generally long enough to provide robust security against password attack.

At block 1215 in FIG. 12, the random string 1016 in the key field 912 is combined with a first reserved string 1021, used to populate the reserved field 904 to form the random privacy key 1012. As shown in the enumerated example 1026, the random privacy key 1012 uses a 2 digit reserved field and 10 digit random string {00}+{0060341394} so that the random privacy key 1012 has a total of 12 numeric digits. The {00} string in the reserved field 904 designates the privacy key as a random privacy key. Although the first reserved string 1021 is shown as being pre-pended to the random string 1016 in FIG. 10, it is emphasized that this location is a matter of design choice and other locations are also contemplated as being utilizable. For example, the first string 1021 may be appended to random string 1016, or inserted into random string 1016 at some predefined position.

As shown in the detailed view of the reserved field indicated by reference numeral 1021A in FIG. 10, the two digits are mapped to specific state identifiers. In this illustrative example, the {00} reserved field indicates that the second digit is used to identify a default privacy state. As shown, the second digit of “0” indicates the default privacy state is disabled. The first digit is used to identify a PIN origin when a PIN is used instead of the random string 1016.

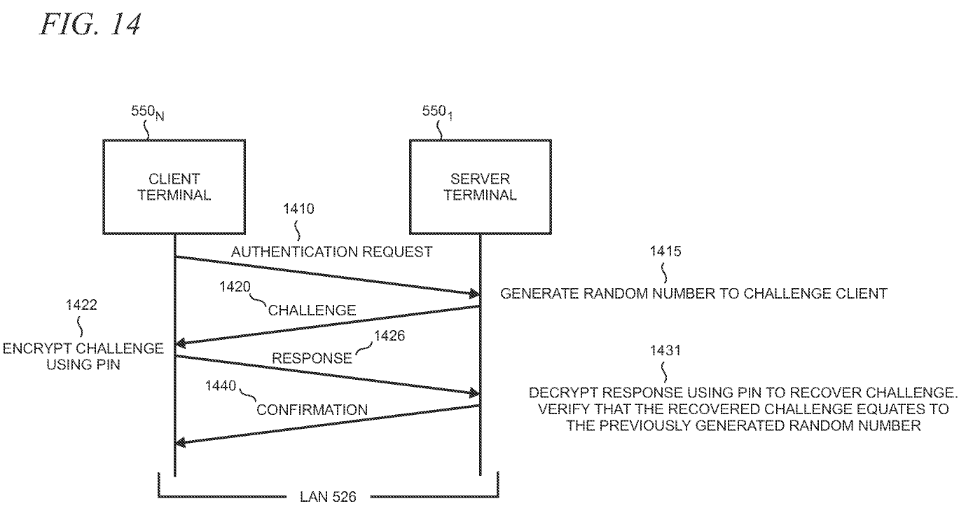

Referring again to FIG. 12, at block 1221, the random privacy key 1012 is used by the STB 805 to form a secure network. One example of such formation is shown in FIG. 14 and described in the accompanying text. Illustrative method 1210 ends at block 1255.

At decision block 1209, if the result of the determination at block 1205 is that privacy is enabled, then control passes to block 1226. At block 1226 (referring to FIG. 11) privacy key logic 850 acquires a PIN 1116 from an external source. The PIN 1116 may be acquired using two alternatives. Below block 1226, on the left branch, the user interface 810 is provided at block 1229 in order to prompt and receive a PIN from a user as shown at block 1231. On the right branch below block 1226 a PIN is received from a controller such as the PIN provisioning subsystem 725 in FIG. 7 as indicated by block 1235. The acquired PIN 1116 is used to populate the key field 912. The acquired PIN 1116 may alternatively comprise numbers, binary bits, an alphanumeric string, or a character string. The length of the acquired PIN 1116 and corresponding key field size can vary according to requirements of a specific application of privacy key provisioning. However, as noted above, a privacy key having between 10 and 15 digits is generally long enough to provide robust security against password attack in most applications.

At block 1240 in FIG. 12, the acquired PIN 1116 in the key field 912 is combined with a second reserved string 1121 used to populate the reserved field 904 to form the configured privacy key 1112. As shown in the enumerated example 1126, the configured privacy key 1112 uses a 2 digit reserved field and 10 digit acquired PIN {01}+{0045601234} so that the configured privacy key 1112 has a total of 12 numeric digits. The {01} string in the reserved field 904 designates the privacy key as a configured privacy key.

As shown in the detailed view of the reserved field indicated by reference numeral 1121A in FIG. 11, the two digits are again mapped to specific state identifiers. In this illustrative example, the {01} reserved field indicates that the second digit is used to identify a default privacy state. As shown, the second digit of “1” indicates the privacy state is enabled by default. The first digit is used to identify that the acquired PIN 1116 is acquired from the user as shown in blocks 1229 and 1231.

Referring again to FIG. 12, control passes from block 1240 to block 1221, where the configured privacy key 1112 is used by the STB 805 to form a secure network.

It is noted that an STB that is first initialized with the random privacy key 1012 may subsequently be reset using a configured privacy key 1112. In such cases, the random privacy key first used can be easily identified by the {00} in the reserved field. Privacy key logic 850 (FIG. 8) is arranged to replace the random privacy key with the configured privacy key and the STB 805 is reset (for example, to reinitialize the NIM 832) so that STB 805 may join a network using the new privacy key. Illustrative method 1210 ends at block 1255.

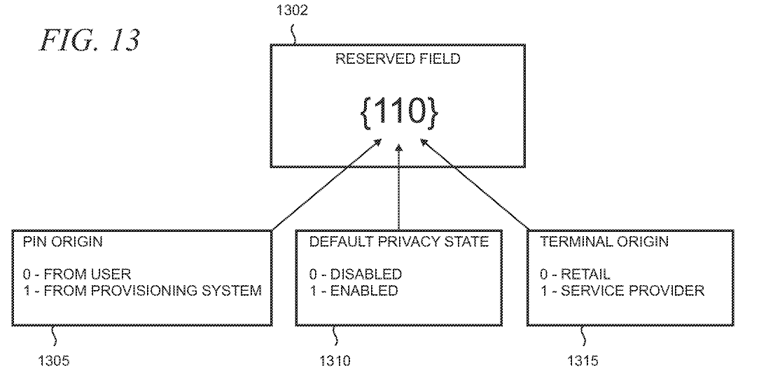

It is emphasized that the reserved field used in the privacy key may be expanded as required to meet the needs of a specific application of privacy setting provisioning. For example, FIG. 13 shows an illustrative mapping of terminal state information to a reserved field 1302 having three digits. The first digit maps PIN origin as indicated by reference numeral 1305. The second digit maps the default privacy state of STB 805 (FIG. 8) as indicated by reference numeral 1310. The third digit maps terminal origin as indicated by reference numeral 1315. Here, a value of “0” indicates that the STB 805 is supplied at retail. A value of “1” indicates that the STB 805 is rented, for example, from an MSO or other service provider.

FIG. 14 is a diagram showing an illustrative shared-key authentication message flow between the server terminal 550₁ and one or more of the other terminal devices 550 (hereinafter referred to singly as a client terminal 550_{N}) that are shown in FIG. 5 over LAN 526. Server terminal 550₁ and the client terminal 550_{N} are able to use shared-key authentication by employing a commonly-utilized privacy key (e.g., random privacy key 1012 shown in FIG. 10 or the configured privacy key 1112 shown in FIG. 11).

In this illustrative example, the messages are conveyed as MAC (media access control) sublayer messages which are transported in the data link layer of the OSI (Open Systems Interconnection) model on the IP network which operates on LAN 526 (FIG. 5). Client terminal 550_{N} sends an authentication request message 1410 to server terminal 550₁. Client terminal 550_{N} sends the authentication request when looking to join (i.e., gain access to) LAN 526 to thereby consume stored content (such as programming recorded on the DVR disposed in the server terminal). In response to the authentication request, server terminal 550₁ generates a random number as indicated by reference numeral 1415. The random number is used to create a challenge message 1420 which is sent back to client terminal 550_{N}.

As indicated by reference numeral 1422 in FIG. 14, client terminal 550_{N} encrypts the challenge using the commonly-utilized privacy key. Client terminal 550_{N} uses any of a variety of known encryption techniques, such as the RC4 stream cipher, to encrypt the challenge (as indicated by reference numeral 1422) using the privacy key to initialize a pseudorandom keystream. Client terminal 550_{N} sends the encrypted challenge as a response message 1426 to the server terminal 550₁.

As indicated by reference numeral 1431 in FIG. 14, the server terminal 550₁ decrypts the response message 1426 using the commonly-utilized privacy key to recover the challenge (i.e., the privacy key acts as an encryption and decryption “key”). The recovered challenge from the client terminal 550_{N} is compared against the original random number. If a successful match is identified, a confirmation message 1440 is sent from the server terminal 550, to the client terminal 550_{N}.

Each of the processes shown in the figures and described in the accompanying text may be implemented in a general, multi-purpose or single purpose processor. Such a processor will execute instructions, either at the assembly, compiled, or machine-level to perform that process. Those instructions can be written by one of ordinary skill in the art following the description herein and stored or transmitted on a computer readable medium. The instructions may also be created using source code or any other known computer-aided design tool. A computer readable medium may be any medium capable of carrying those instructions and includes a CD-ROM (compact disc read-only-memory), DVD (digital versatile disc), magnetic or other optical disc, tape, silicon memory (e.g., removable, non-removable, volatile or non-volatile), packetized or non-packetized wireline or wireless transmission signals.

What is claimed is:

1. A terminal device, comprising:
a user interface arranged to be capable of receiving a user password from a user;
a network interface arranged a) for receiving multimedia content from a multimedia provider over a wide area network, and b) to be capable of receiving a network password from the multimedia provider over the wide area network; and
privacy key logic arranged for a) creating a random privacy key comprising a first reserved string and a randomly generated string, and b) creating a configured privacy key comprising a second reserved string and either the user password or the network password.

2. The terminal device of claim 1 in which the user interface comprises a graphical user interface displayable on a presentation device, the presentation device selected from one of television, display screen, or monitor.

3. The terminal device of claim 1 in which the first reserved string is different from the second reserved string.

4. The terminal device of claim 1 in which the privacy key logic is implemented by one of application, firmware, or a combination thereof.

5. The terminal device of claim 1 in which the privacy key logic is implemented by an application specific integrated circuit.

6. The terminal device of claim 1 further including a memory.

7. A method for provisioning a privacy setting on a networkable terminal device, the method comprising:
determining a default privacy setting for the terminal device;
responsively to the determining, generating a random string if the privacy setting is disabled by default, and acquiring a password if the privacy setting is enabled by default; and
generating a privacy key that is arranged from either a) a first reserved string and the random number, or b) a second reserved string and the password.

8. The method of claim 7 in which the privacy key is selected from one of random privacy key or configured privacy key.

9. The method of claim 7 in which the password is received from a user utilizing a local user interface.

10. The method of claim 7 in which the password is received over a network from a remote system.

11. The method of claim 7 further including using the privacy key to form a secure network with one or more networkable terminal devices.

12. A computer-readable medium having stored thereon an object representing a privacy key usable for implementing secure communication among terminal devices on a network when the devices are each instantiated with the privacy key, the object comprising:
a key field selected from one of randomly-generated string or acquired string, the acquired string being received at an input to at least one of the devices; and
a reserved field that is arranged to differentiate the privacy key according to one or more class attributes shared by the terminal devices.

13. The computer-readable medium of claim 12 in which the randomly-generated string is created when a privacy setting of a terminal device is disabled by default.

14. The computer-readable medium of claim 12 in which the acquired string is acquired when a privacy setting of a terminal device is enabled by default.

15. The computer-readable medium of claim 12 in which the acquired string is acquired by receiving a PIN value from a user.

16. The computer-readable medium of claim 12 in which the acquired string is acquired by receiving a value from a controller disposed on the network.

17. The computer-readable medium of claim 16 in which the value is a unique identification.

18. The computer-readable medium of claim 17 in which the unique identification is selected from one of terminal association identifier, PIN, hash value of the terminal association value, or hash value of the PIN.

19. The computer-readable medium of claim 12 in which the reserved field is concatenated with the random string or acquired string to form the privacy key.

20. The computer-readable medium of claim 12 in which the reserved field is inserted into the random string or acquired string to form the privacy key.
